(19) United States
(12) Patent Application Publication
(10) Pub. No.: US 2004/0141753 A1
(43) Pub. Date: Jul. 22, 2004

(54) Apparatus and method for tracking in free-space optical communication systems

(75) Inventors: Christian Andreu-von Euw, San Diego, CA (US); Brian W. Neff, Solano Beach, CA (US); Zhenmin Zhou, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: LightPointe Communications, Inc., San Diego, CA

(21) Appl. No.: 10/349,488

(22) Filed: Jan. 21, 2003

(51) Int. Cl. H04B 10/00

(52) U.S. Cl. 398/122

(57) ABSTRACT

The present invention provides an apparatus and method for tracking alignment between transceivers for free-space optical communication. The method comprises the steps of receiving a received narrow optical beam, determining an angle at which the optical beam is received, quickly shifting an alignment such that the alignment minimizes the angle, and directing a narrow transmit optical beam along the alignment. The method further shifting the alignment through at least a portion of a search pattern searching for the receive beam. The apparatus provides free-space optical communication, comprises an optical beam detector configured to receive a received narrow tracking beam, an optical beam source configured to generate a narrow transmit tracking beam, and a controller configured to determine an angle of reception of the receive beam and to control a direction of transmission of the transmit beam such that the angle is minimized.

### BACKGROUND OF THE INVENTION

1. Field of the Invention

The present invention relates generally to free-space optical communication, and more specifically to alignment tracking control in free-space optical networks.

2. Discussion of the Related Art

For digital data communications, optical media offers many advantages compared to wired and RF media. Large amounts of information can be encoded into optical signals, and the optical signals are not subject to many of the interference and noise problems that adversely influence wired electrical communications and RF broadcasts. Furthermore, optical techniques are theoretically capable of encoding up to three orders of magnitude more information than can be practically encoded onto wired electrical or broadcast RF communications, thus offering the advantage of carrying much more information.

Fiber optics are the most prevalent type of conductors used to carry optical signals. An enormous amount of information can be transmitted over fiber optic conductors. A major disadvantage of fiber optic conductors, however, is that they must be physically installed.

Free-space atmospheric links have also been employed to communicate information optically. A free-space link extends in a line of sight path between the optical transmitter and the optical receiver. Free-space optical links have the advantage of not requiring a physical installation of conductors. Free-space optical links also offer the advantage of higher selectivity in eliminating sources of interference, because the optical links can be focused directly between the optical transmitters and receivers, better than RF communications, which are broadcasted with far less directionality. Therefore, any adverse influences not present in this direct, line-of-sight path or link will not interfere with optical signals communicated.

Despite their advantages, the quality and power of the optical signal transmitted depends significantly on the alignment between cooperating link heads.

It is with respect to these and other background information factors relevant to the field of optical communications that the present invention has evolved.

### SUMMARY OF THE INVENTION

The present invention advantageously addresses the needs above as well as other needs by providing an apparatus and method for tracking alignment between transceivers of a free-space optical communication network or system. The method can be utilized in free-space optical communication, comprising the steps of: receiving a received narrow optical beam; determining an angle at which the optical beam is received; quickly shifting an alignment such that the alignment minimizes the angle; and directing a narrow transmit optical beam along the alignment. In one embodiment, the method further comprises the step of searching for the received optical beam prior to the step of receiving includes shifting the alignment through at least a portion of a search pattern.

In another embodiment, the invention provides a method for use in optically communicating over free-space, comprising the steps of: detecting a received narrow free-space optical beam; determining a direction from which the receive optical beam is received; adjusting a direction of alignment to correspond with the direction from which the receive optical beam is received; and transmitting a narrow transmit free-space optical beam along the direction of alignment, wherein the step of adjusting includes quickly adjusting the direction of alignment.

In another embodiment, the invention provides an apparatus for use in free-space optical communication, comprising: an optical beam detector configured to receive a received narrow tracking beam; an optical beam source configured to generate a narrow transmit tracking beam; and a controller coupled with the beam detector, wherein the controller is configured to determine an angle of reception of the receive beam and to control a direction of transmission of the transmit beam such that the angle is minimized. The apparatus can be further configured such that the optical beam detector and the optical beam source are movable such that the optical beam detector and optical beam source are slowly moved to detect the optical tracking beam and are quickly moved to minimize the angle when the tracking beam is detected.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a free-space optical communication network according to one embodiment of the present invention;

FIG. 2 depicts a simplified block diagram of a previous free-space optical communication link;

FIG. 3 depicts a simplified block diagram of a free-space optical communication system or link according to one embodiment of the present invention;

FIG. 4 depicts a simplified block diagram of a cross-sectional view of a pair of cooperating and communicating link heads according to one embodiment of the present invention;

FIGS. 5-8 depict simplified block diagrams of two cooperating link heads optically communicating over a free-space link; and

FIG. 9 depicts a simplified flow diagram of a process for determining and adjusting the direction of transmission according to one embodiment of the present invention.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

A free space optical network is one in which high-speed network connectivity is achieved by modulating data onto an optical beam carrier and transmitting the optical information through free space to a receiver at some distance away. Free space networks provide communication at data rates that are comparable to fiber optics data rates while avoiding the cost and time associated with installing fiber optic cabling.

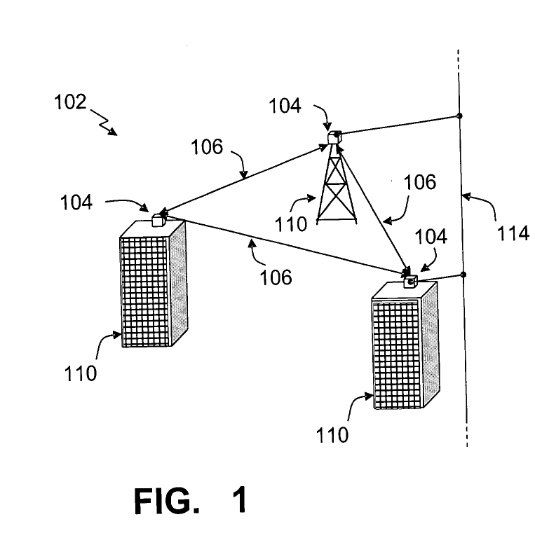

FIG. 1 depicts a free-space optical communication network 102 according to one embodiment of the present invention. The network includes a plurality of link heads 104. Each link head comprises a transmitter, a receiver or both a transmitter and receiver (i.e., a transceiver). A link head 104 is optically aligned with at least one other link head on opposite sides of one or more free-space links 106. The link heads are mounted to structures 110, such as buildings, antennas, bridges, poles, houses and other structures. The link heads can be coupled with a network 114, such as the Internet, an inter-campus network, a Public Switched Telephone Network (PSTN), cable television, cellular backhaul or other networks capable of communicating data and/or information.

These link heads 104 are precisely aligned in order to provide free-space communication across the links 106. If the link heads become misaligned, communication between the link heads fails. Many factors can affect the alignment between link heads, including the stability of the mounting, the stability of the structure 110 (e.g., buildings can sway due to winds, seismic activity, etc.) and other such factors. Similarly, natural and man-made events can also affect the alignment. For example, wind can shift or alter the alignment of a link head, hail can impact a link head changing the alignment, interfering factors can bump, jar or move a link head causing it to shift from alignment such as birds landing on the link head, maintenance workers bumping into the link head and other similar interfering factors, and other similar events can cause misalignment. Furthermore, optical beams naturally diverge as they travel greater distances. Divergence describes the rate at which a laser beam widens as it leaves the link head.

In previous free space optical networks, one method of attempting to reduce communication errors caused by misalignment and atmospheric conditions was by utilizing a beacon or tracking beam that is transmitted with a large diverge. A transmitted beacon beam diverges into a large cross-sectional profile at a receiver located some distance away from the transmitting device. In this way, small-scale deflections or misdirections are reduced as a percentage of beam width at the receiver. The wide transmit beacon make a far field link head relatively immune to small pointing errors from the near field transmitting link head. Previous systems utilize optical receivers with receive objectives that are much smaller than the typical diverged beam width at the receiver. The large divergence reduces the amount of light received by the receiver because only a percentage, and generally a small percentage, is detected by the receiving link head. As a result, much of the received power is not detected and is thus lost. The consequence of this is wasted power, a reduction in received signal power, reduction of the signal-to-noise ratio and subsequently an introduction of undesirable errors.

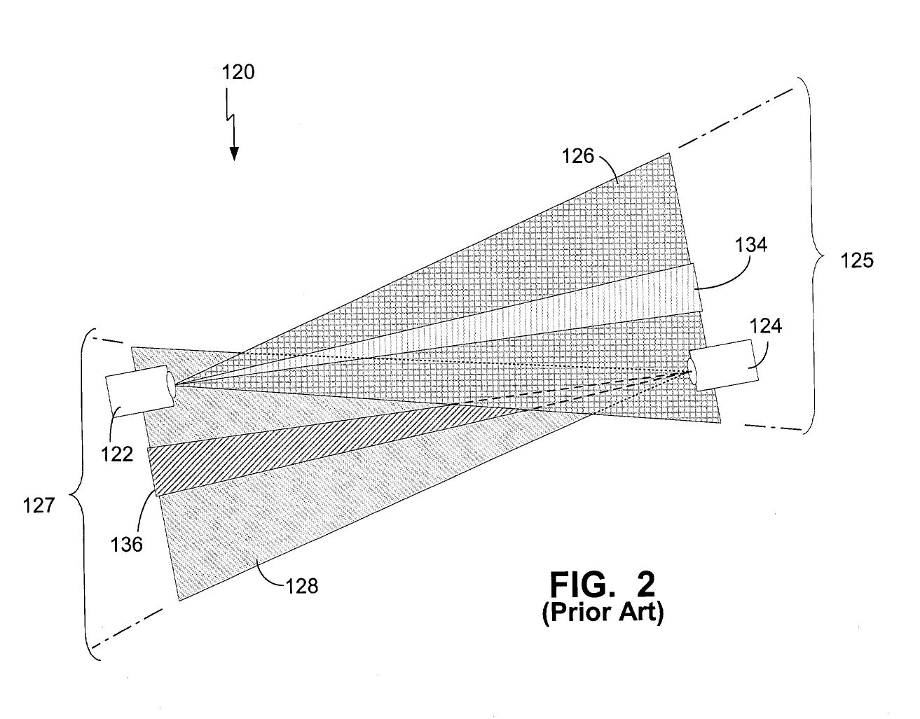

FIG. 2 depicts a simplified block diagram of a previous free-space optical communication link 120. Two link heads 122 and 124 are positioned on opposite sides of the link to establish communication between the link heads. To maintain alignment, previous systems transmit beacon or tracking signals 126 and 128. Previous systems utilized wide or large diverging 125, 127 tracking beams. The large diverging beams attempt to provide easy alignment because the link heads have to be extremely misaligned to be outside of the large diverged beam diameter. Systems with a wide divergence tends be more immune to link head movement and to movement of the structure on which they are mounted.

In FIG. 2, it can be seen that the link heads 122, 124 are severely misaligned and the data signals 134,136 are not being received by either link head. However, because of the wide divergence 125, 127 of the tracking beams 126, 128, each link head is still able to detect the tracking beams, assuming weather conditions do not attenuate the wide spread, low power tracking beam to a level below which the receiving link head can detect the beam. Once a link head detects the large diverging tracking beam, the link head can attempt to adjust its alignment in an attempt to realign itself to receive the data beam 134.

However, because the large divergence is utilized to ensure that the tracking signal 126,128 impinges on the cooperating link head even when severely misaligned, the tracking beam is widely spread resulting in large amounts of wasted light and power. As such, excess energy is wasted and the received signal power of the tracking beam is low. This low received power can result in the receiving link head being unable to detect the beam, or in adverse environmental conditions the low beam power is further reduced, further limiting or preventing tracking beam detection.

The present method, apparatus, system and network provide for tracking and power level control of transmitted and received beams to maintain alignment between link heads and to overcome the disadvantages and drawbacks of previous free-space communication networks, including compensating for beam misdirection, misalignment and power loss. By controlling beam direction, pointing and alignment to accurately impinge on a receiver, a beam diameter and divergence can be significantly reduced. This allows the beam cross-section size at the receiver to be much more closely matched to the optical receiver, leading to a greater transfer of the available power into the receiver. The present invention further employs signal tracking control that further leads to a greater signal-to-noise ratio and reduces or eliminates undesirable errors.

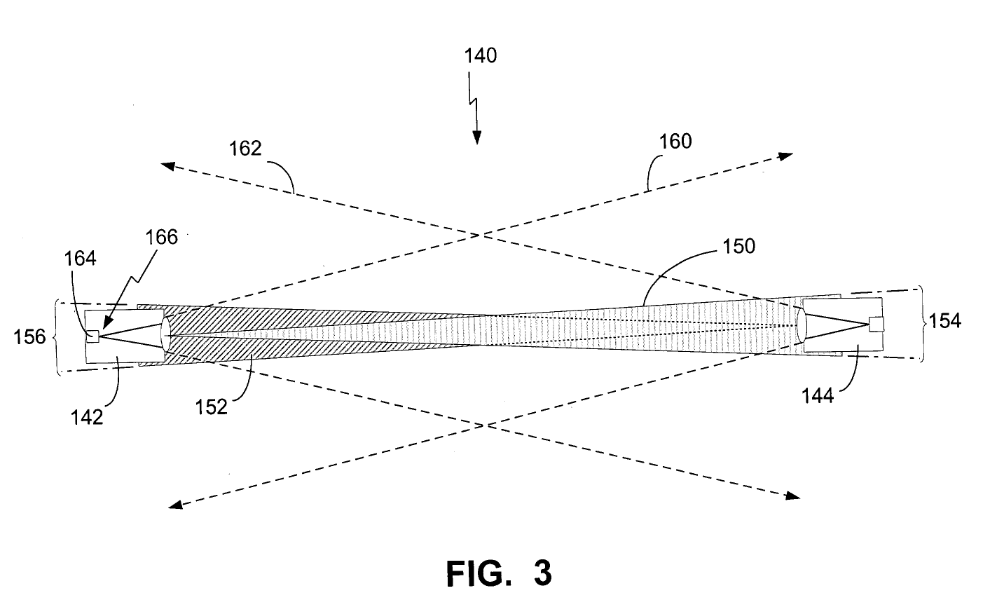

FIG. 3 depicts a simplified block diagram of a free-space optical communication system or link 140 according to one embodiment of the present invention. The system includes two or more optical transceiver units or link heads 142, 144 configured to communicate over free-space. Typically, the system communicates medium to high data rate signals across free space. Each link head has one or more transmit laser beams (data, control and/or tracking beams), which are received by the far end link head. These beams are modulated to create a communications channel.

The present invention optimizes alignment by utilizing narrow transmit beams 150, 152 with a small divergence 154,156 relative to the divergence of tracking beams seen in previous systems. The narrow beams 150,152 improve received signal power and reduce the amount of wasted light and power. A narrow divergence concentrates more of the laser beam onto the far end link head. This increased efficiency is used to increase the reliability of the system and/or increase the range of the system. However, as the divergence is narrowed, ease of alignment is negatively affected.

The present invention employs an active tracking system which allows the present invention to utilize narrow beams. The tracking system corrects the link head alignment. As such, the link heads can additionally be mounted on much less stable platforms than static link heads, and/or can utilize a narrower beam allowing for more reliable long range communication systems.

The amount of divergence 154, 156 is dictated by the size of the link heads, the size of the receiving optics, the distance between link heads and other similar factors. However, the divergence is maintained at a relatively narrow width compared with previous systems.

In one embodiment of the present invention, the link heads 142, 144 are configured with wide fields of view 160, 162. The field of view is the complement to the divergence. The divergence refers to the angle formed by light leaving a link head. The field of view is an amount of space that can be seen by the receiver at one time, commonly described by the maximum angle formed by light entering the receiver. If light is entering from too steep an angle, the light is outside the receiver field of view. A wide field of view combined with the present inventions tracking system overcomes the limitations of utilizing a narrow tracking or data beam.

The tracking system of the present invention uses a transmit beam transmitted over the link 140. The transmit beam can be a data beam, a tracking or beacon beam, or substantially any other beam or combination of beams. Typically, each link head in the system or network includes a beacon or tracking beam source, such as a laser, LED or other source, that generates the tracking beam 150, 152. The tracking beam gives a far field link head a direction in which to direct its transmitting data beams. When the link heads 142, 144 are roughly aligned, the first link head detector or receiver board 164 is able to detect the second link head tracking beam 152. The receiver 164 is able to detect the angle of the incoming light and thus the position of the second link head 144. The first link head 142 can then make adjusts to its position and/or direction of transmission if needed to minimize the detected angle and thereby ensuring that it is pointed directly at the second link head.

Typically, the second link head 144 additionally receives the first link head tracking beam 150 and determines adjustments to minimize the detected angle and maximize alignment. In one embodiment, both link heads continuously determine the received angle to ensure that they remain pointed at each other. Alternatively, the link heads can randomly determine the receive angle or determine the receive angle according to a schedule. The link heads can also be configured to wait to implement positioning and/or direction of transmission adjustments until the detected angle of alignment exceeds a predefined amount, limit or threshold. This limits the movement of the link head and reduces the operational over head.

In one embodiment, the link head(s) 142, 144 employs a quad-cell detector 164 for detecting the beam 150, 152. The quad-cell allows for the detection of the angle from which the received narrow optical beam is transmitted. This allows the link head to adjust positioning and alignment of its own transmit beam (for data, information and/or tracking) at the detected angle. Utilizing the quad-cell provides for a simplified design of the link head detection system, at a reduced cost compared with previous systems, such as those employing CCDs. However, the present invention can be implemented utilizing one or more CCDs, silicon single cell position sensing devices (PSD) or substantially any other optical signal detection device or devices. Typically, the quad-cell is positioned at a detection focal point 166 to optimize the detection of the angle of the received tracking beam 152.

In one implementation of the present invention, the link heads 142 and 144 operate independently. Each link head monitors the angle at which the tracking beam is received, and each independently adjusts the direction of transmission of its tracking and/or data signal to transmit along the detected angle. Typically, the link heads 142, 144 operate without communicating control and/or transmission adjustment information between the link heads. However, in some embodiments, the link heads can include the capability to communicate control and transmission adjustment information with each other. Because the link heads 142, 144 typically operate independently and without control communication between them, if one link head becomes misaligned the other link head cannot provide correctional instructions to the first link head directing the first link head on how and how much to adjust.

In one embodiment, if a link head or link heads become misaligned and a first link head (e.g., link head 142) cannot detect the data and/or tracking beam from a second link head (e.g., link head 144), the first link head enters a search mode and implements a search pattern to detect and reacquire the second link head. Similarly, if the second link head cannot detect the first link head, the second link head enters a search mode and implements a search pattern to reacquire the first link head.

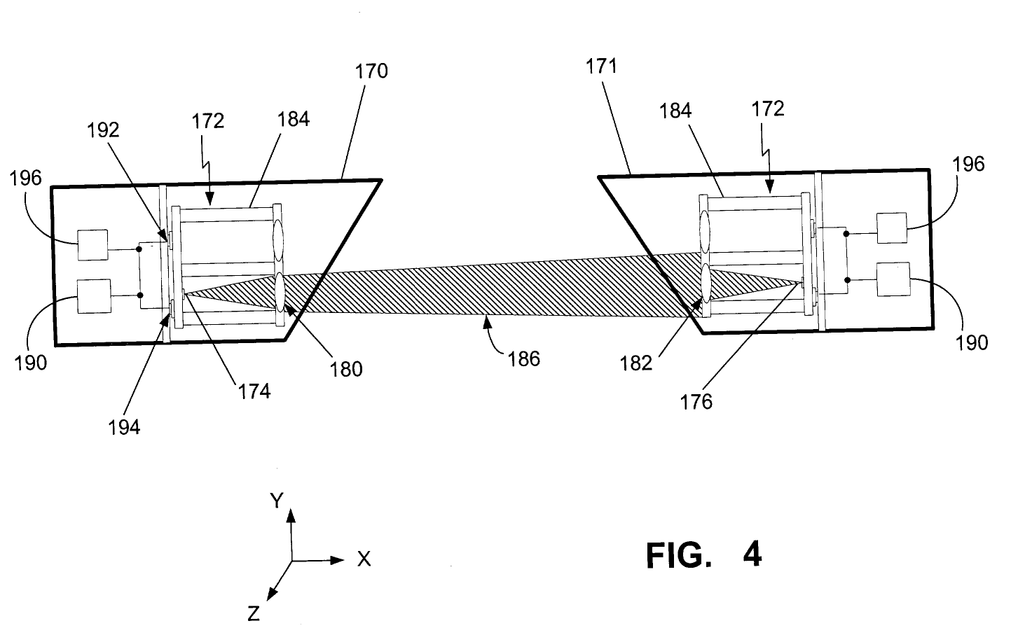

In one embodiment, the search pattern is implemented by moving the optical components of the link head. As such, the link head is not moved, just the optical components. FIG. 4 depicts a simplified block diagram of a cross-sectional view of a pair of cooperating and communicating link heads 170, 171 according to one embodiment of the present invention. Each link head includes optical components 172. The optical components 172 can include optical signal generators 174 (e.g., lasers, LEDs and the like) and optical signal detectors 176 (e.g., quad-cell(s), CCDs, single cell PSDs, photodiodes and the like). Typically, each link head 170 includes one or more optical signal generators 174 and one or more optical signal detectors 176. The optical components can further include lenses, gradients, telescope assemblies, filters, collimating, limiting divergence and other optics 180, 182 for focusing, filtering and other such conditioning of the transmit and/or receive optical signals 186.

In one embodiment, the link heads include an optical assembly, gimbal or optics cage 184, wherein the optics, lasers and/or detectors are secured. The optical assembly is configured to move to achieve alignment. The optical assembly 184 can adjust the pointing of the link head adjusting both the azimuth and elevation to adjust the positioning and/or alignment of the optical components 172. Further, the electronics 190 and other components of the link head 170 are static or in a fixed position. In one embodiment, the optical assembly 184 and optical components 172 are moved by one or more linear motors 192. The link heads 170, 171 can include one or more positioning sensors 194 that detect the positioning of the optical assembly 184 and/or optical components 172 and monitors the change of positioning as the optical assembly is moved.

In one embodiment, the link heads include a controller 196 that controls the operation of the motors and the movement of the optical assembly 184 according to the positioning as indicated by the sensor(s) 194. The controller can be implemented through, but not limited to, a microprocessor, a CPU and/or substantially any other controller. The controller can include and/or access a memory for storing and retrieving information, such as power levels, statistical information, control procedures, look-up tables and other data and information. The controller additionally is coupled with the detector to determine the angle of the received beam. Based on position information from the sensor 194, the controller is configured to determine adjustments to optimize alignment along the angle minimizing the angle.

The optical assembly 184 and motor(s) 192 implement the search pattern(s) as dictated by the controller. One example of a search pattern is a spiral from a center point out or spiral in towards the center point. The spiral can initiate from a center point within the field of view, from a point where receive beam was last detected, from a point where on average a maximum power is typically received, or other similar points within the range of movement and field of view of the link head. Alternatively and/or additionally, the search pattern can be a horizontal and/or vertical serpentine pattern. Other similar search patterns can also be employed. Typically, the controller monitors the reception of the received beam. In one embodiment, if the beam is undetected for a predefined period, the controller initiates the search pattern.

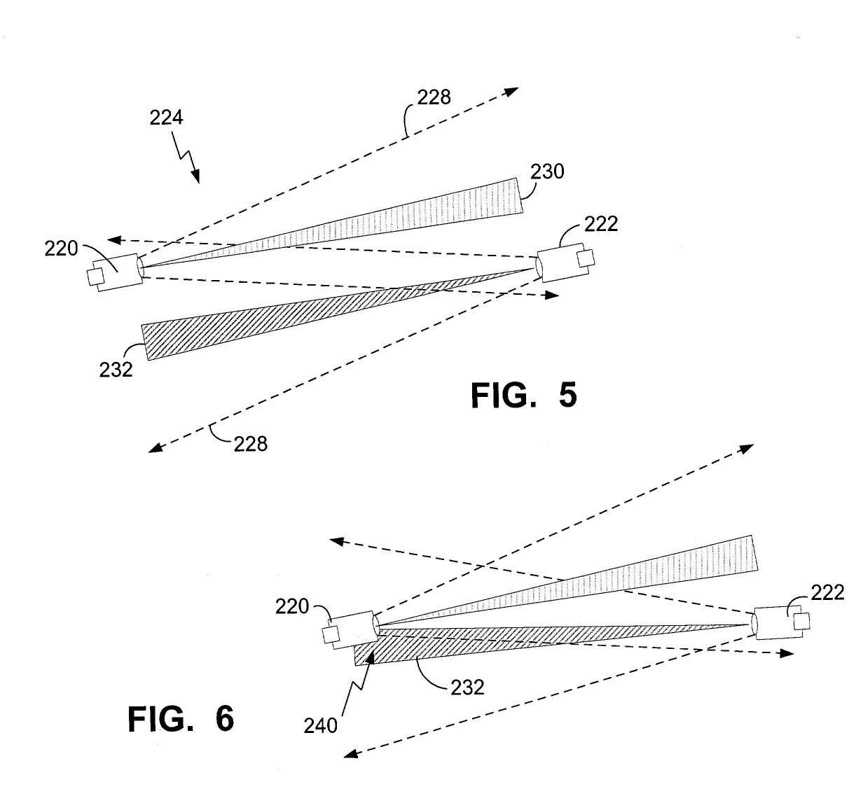

FIGS. 5-8 depict simplified block diagrams of two cooperating link heads 220, 222 optically communicating over a free-space link 224. One or both to the link heads typically transmit a beam 230, 232. The transmit beam can be transmitted continuously, periodically, randomly or as dictated through scheduling. The transmit beam can be a beacon or tracking beam, a data beam or other similar beams. In FIG. 5, the link heads are severely misaligned; however both link heads remain within the others field of view 228. When such misalignment occurs, one or both of the link heads initiate a search pattern to reacquire the optical alignment. In some embodiments, the search pattern is implemented through slow movements of the link head or optical assembly. During the search pattern, a first link head 220 attempts to detect the tracking beam 232 of the second link head 222. Additionally, the second link head also attempts to detect the tracking beam 230 of the first link head 220.

Referring to FIGS. 6-7, in one embodiment, the search pattern is implemented through movements of the link head or optical assembly. When the first link head 220 detects (indicated generally as 240) the narrow tracking beam 232 of the second link head 222, the first link head 220 or optical assembly 184 is transitioned or repositioned (see FIG. 7, indicated generally as 244) to align with the direction from which the tracking beam 232 is detected. In one embodiment, the search pattern is implemented through slow movements of the link head relative to quick movements of the link head when attempting to align with the far field link head. This quick transition, relative to the slow search pattern movements, allows the first link head to quickly align with the second link, before the second link head 222 can move to a position where the second link head cannot detect the first link head tracking beam. This allows the second link head to then detect the first link head tracking beam 230.

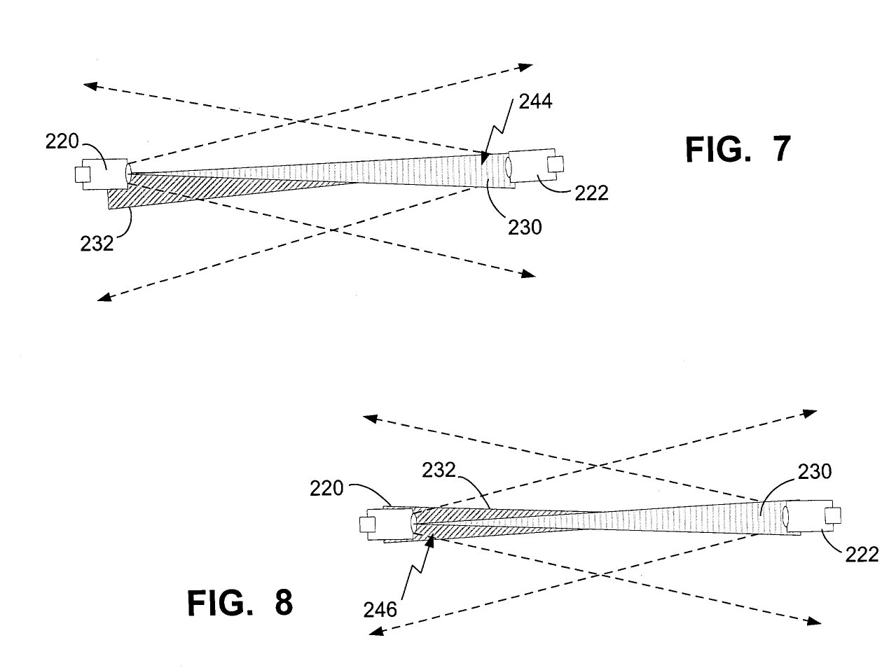

Referring to FIG. 8, once the second link head 222 detects the first link head tracking beam 230, it also quickly transitions or repositions (indicated generally as 246) to align with the first link head 220. As described, the movement of the link head 222 or optical assembly 184 during the search pattern is relatively slow compared with the quick movement of the link head or optical assembly when attempting to quickly align with the detected beam 230.

In some embodiments, the movements of the link heads during the search pattern are not slow compared with the movements of the link heads when aligning with the far field link head. In these embodiments, as a first or near field link head 220 detects the beam 232 from the second or far field link head 222, it registers the angle from which the beam is received. The first link head then transitions to align with the angle of detection. The second link head 222 continues to implement the search pattern and the first link head maintains its position. If the first link head 220 does not transition into alignment before the second link head shifts to a position where it cannot detect the beam 230 from the first link head, the second link head continues the search until it shifts to a position where it does detect the beam 230 from the first link head. Once the bean 230 is detected, the second link head is shifted to align with the received beam.

In one embodiment, the link heads of the present invention additionally include optical filters to differentiate between communication and/or tracking lasers and background light. In one embodiment, the present invention additionally modulates the transmitted data and/or tracking beam(s) at a predefined tone frequency in the time domain (i.e., 20 KHz modulation, 100 KHz modulation, 1 MHz modulation or other frequencies or combination of frequencies) and can have a predefined optical wavelength (i.e., 850 nm, 1350 nm or other wavelengths). For example, a tracking beam 150, 152 (see FIG. 3) can be transmitted to pulse at 20 KHz. As such, the link head only considers received optical signals at the predefined frequency and wavelength. The receiver includes a tone detection circuit that ignores or eliminates signals at different frequencies. This significantly increases the noise filtering. Other signals that are not at the predefined frequency are ignored. For example, a constant light source impinging on the detector is ignored because it is not pulsed at the predefined frequency. Further, if sun light impinges on the detector, even though the sun light may be several times greater in magnitude than tracking signals, the small component of the sun light at the predefined frequency is very low. The present invention can be implemented with substantially any predefined signal pattern so that the desired signal can be distinguished over other signals and/or noise.

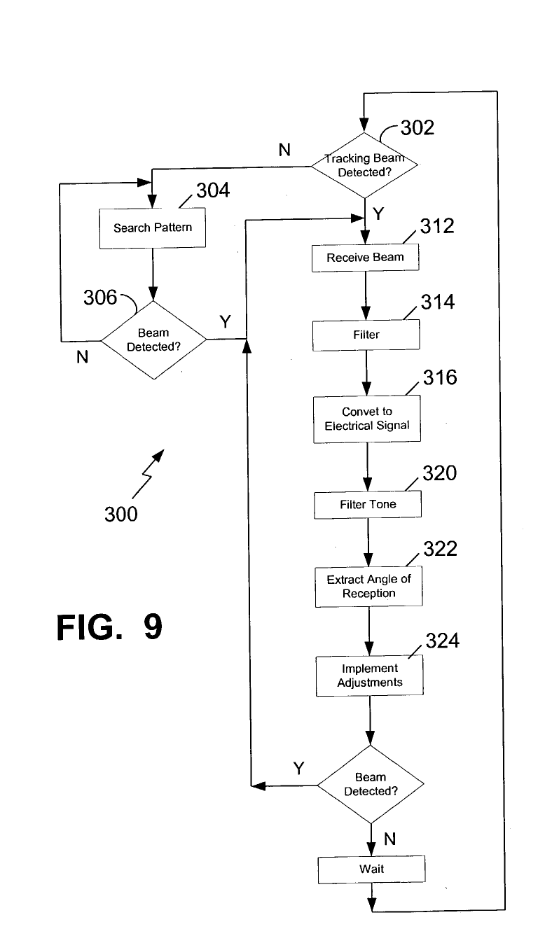

FIG. 9 depicts a simplified flow diagram of a process 300 for determining and adjusting the direction of transmission according to one embodiment of the present invention. Initially, the far field link head modulates a transmit beam at the predefined frequency and transmits the beam. In step 302, it is determined if the beam is detected or acquired. If not, step 304 is entered where a search pattern is implemented. In step 306, it is determined if the beam is detected. If not, the process returns to step 304 to continue implementing the search pattern.

If the beam is detected in step 302 or step 306, step 312 is entered where the receiving link head receives the transmit beam and other optical interference and noise if present. In step 314, the receiving link head filters the received signal through an optical filter to filter out only those signals with the predefined tone. In step 316, the link head converts the received and noise signals to an electrical signal. In step 320, a frequency filter is used to filter out the noise extracting the received beam at the predefined tone. In step 322, the positioning information and/or receiving angle of the received beam is determined. In step 324, the positioning information is forwarded to the controller which implements adjustments to the optical assembly according to the positioning information. In step 326, it is determined if the beam is detected. If not, step 330 is entered where the process 300 waits a period of time, whether random or scheduled. The process then proceeds back to step 302. If in Step 326 the beam is detected the process returns to step 312.

In one embodiment, once a link head can no longer detect a coopering link head at the opposite side of the free-space communication link, the link head waits for a period of time to ensure that what appears to the first link head as a misalignment is not due to a power glitch, a temporary blockage of the tracking signal, and other similar conditions that are not necessarily misalignments, for example a bird passing through the tracking beam.

In one embodiment, when severe misalignment occurs, only one link head (e.g., first link head 220) implements the search pattern while the other (e.g., the second link head 222) returns to a predefined set position. In one embodiment, the second link head remains in the predefined set position for a first predefined period of time. If the second link head does not detect the tracking beam 230 of the first link head within a second predefined period of time, the second link head then initiates a search pattern. The first link head can be configured to continue searching after the second predefined period or can be configured to halt the search and return to a predefined set position.

In one embodiment, the controller maintains statistics on the direction of transmission. As the link head shifts positioning it maintains the number of times the link head is in that position or within a range of positions (e.g., ±0.25°). The controller then utilizes the statistics in implementing the search mode. For example, the controller can initiate the search mode to transition between the five positions most often implemented that statistically provided maximum receive power. The search can transition between these five for a first predefined period. If the link head does not acquire the cooperating link head within the first predefined period of time, the controller can direct the search to transition between the ten positions most often implemented for a second predefined period. This search mode can continue for fixed periods of time. If the cooperating link head is not acquired, the link head can then transition to a spiral, serpentine or other search pattern.

The present invention can be further configured to monitor the alignment and communication. If the alignment is down for a predefined period of time after the search mode or pattern is implemented, the controller communicates through an alternate optical free-space link or alternate mode of communication (e.g., radio frequency (RF), fiber optic cable, telephony, or other modes of communication) to a central controller that the link is down.

In addition to monitoring received beams, in one embodiment, the present invention monitors the power level of the received data signal. As discussed above, data and/or information is communicated over the free-space links 106 (see FIG. 1). Each link head can include a detector that detects the data beam. The link head can be configured to determine a power level of the detected data beam. The link head can then utilizes changes in the power level as the optical assembly 184 or link head is shifted in attempts to optimize alignment. If the received power level of the data signal drops the controller reverses the adjustment or makes other adjustments in an attempt to maximize the received power.

In one embodiment, the alignment based on receive power is implemented as described fully in co-pending U.S. application Ser. No. 10/326,852, entitled MEHTOD AND APPARATUS FOR MAINTAINING OPTICAL ALIGNMENT FOR FREE-SPACE OPTICAL COMMUNICATION, filed Dec. 20,2002, incorporated in its entirety herein by reference.

While the invention herein disclosed has been described by means of specific embodiments and applications thereof, numerous modifications and variations could be made thereto by those skilled in the art without departing from the scope of the invention set forth in the claims.

What is claimed is:

1. A method for use in free-space optical communication, comprising the steps of:
receiving a received narrow optical beam;
determining an angle at which the optical beam is received;
shifting an alignment such that the alignment minimizes the angle wherein the alignment is shifted before the received optical beam leaves a field of view; and
directing a narrow transmit optical beam along the alignment.

2. The method as claimed in claim 1, wherein the received optical beam is a tracking beam.

3. The method as claimed in claim 2, further comprising the step of:
searching for the received optical beam prior to the step of receiving includes shifting the alignment through at least a portion of a search pattern.

4. The method as claimed in claim 3, further comprising the step of:
detecting that the received optical beam is no longer being received prior to the step of searching.

5. The method as claimed in claim 3, wherein the step of shifting the alignment such that the alignment minimizes the angle is performed wherein the shifting occurs quickly relative to the step of searching.

6. The method as claimed in claim 1, further comprising:
detecting the received narrow optical beam; and
verifying a tone of the received optical beam prior to the step of determining the angle.

7. The method as claimed in claim 1, wherein the steps of receiving, determining the angle, shifting the alignment to minimize the angle, and directing are performed without communicating with a far field link head.

8. The method as claimed in claim 1, wherein the step of receiving includes utilizing a wide field of view relative to the received narrow optical beam.

9. A method for use in optically communicating over free-space, comprising the steps of:
detecting a received narrow free-space optical beam;
determining a direction from which the received optical beam is received;
adjusting a direction of alignment to correspond with the direction from which the received optical beam is received; and
transmitting a narrow transmit free-space optical beam along the direction of alignment.

10. The method as claimed in claim 9, wherein the step of adjusting includes quickly adjusting the direction of alignment before the received optical beam is no longer detected.

11. The method as claimed in claim 10, further comprising the step of:
searching for the received optical beam prior to the step of detecting.

12. The method as claimed in claim 9, further comprising the step of:
determining a current direction of alignment prior to the step of adjusting, wherein the step of adjusting is performed if the current direction of alignment is different than the direction from which the received optical beam is received.

13. The method as claimed in claim 9, further comprising the step of:
filtering the received optical beam;
forwarding a portion of the received optical beam having a predefined frequency in a time domain; and
the step of determining the direction including determining the direction of the portion of the received optical beam having the predefined frequency.

14. The method as claimed in claim 13, wherein the step of forwarding includes forwarding a portion of the received optical beam having a predefined optical wavelength.

15. An apparatus for use in providing free-space optical communication, comprising:
an optical beam detector configured to receive a received narrow tracking beam;
an optical beam source configured to generate a narrow transmit tracking beam; and
a controller coupled with the beam detector, wherein the controller is configured to determine an angle of reception of the received beam and to control a direction of transmission of the transmit beam such that the angle is minimized.

16. The apparatus as claimed in claim 14, further comprising:
the optical beam detector and the optical beam source are movable, wherein the controller moves the optical beam detector and optical beam source at a first speed to detect the received tracking beam and moves the optical beam detector and optical beam source at a second speed to minimize the angle when the received tracking beam is detected wherein the second speed is a greater speed than the first speed.

17. The apparatus as claimed in claim 14, further comprising:
an optical assembly in which the optical beam detector and optical beam source are positioned, and the optical assembly is configured to quickly move such that the direction of transmission minimizes the angle such that the alignment is shifted before the received beam leaves a filed of view.

18. The apparatus as claimed in claim 16, further comprising:
a sensor coupled with the optical assembly and with the controller, wherein the sensor monitors the position of the optical assembly and communicates the position to the controller.

19. The apparatus as claimed in claim 14, wherein the optical beam detector is configured with a wide field of view.

20. The apparatus as claimed in claim 18, wherein the optical beam detector includes a quad cell detector.

21. The apparatus as claimed in claim 18, wherein the transmit tracking beam has a narrow beam divergence.
